(19) United States
(12) Patent Application Publication
(10) Pub. No.: US 2026/0357146 A1
(43) Pub. Date: Nov. 12, 2026

(54) SYSTEMS AND METHODS FOR CARBONATE MINERALIZATION DURING NATURAL GAS PROCESSING

(71) Applicant: SAUDI ARABIAN OIL COMPANY, Dhahran (SA)

(72) Inventors: Peng LU, Dhahran (SA); Pan LUO, Dhahran (SA); Bandar GHASSAL, Dhahran (SA)

(73) Assignee: SAUDI ARABIAN OIL COMPANY, Dhahran (SA)

(21) Appl. No.: 19/203,018

(22) Filed: May 8, 2025

(51) Int. Cl. C10L 3/10

(52) U.S. Cl. CPC C10L 3/103

(57) ABSTRACT

Natural gas sweetening may be conducted using a carbonate-forming reagent selected based upon the amount of carbon dioxide in the natural gas. Methods for sweetening natural gas may comprise: providing natural gas comprising a first amount of carbon dioxide; selecting a carbonate-forming reagent based on the first amount of carbon dioxide, wherein the carbonate-forming reagent comprises a high-CO₂ reagent (an alkaline aqueous fluid comprising calcium ions) or a low-CO₂ reagent (an aged aqueous fluid comprising pulverized ultramafic rocks, and/or pulverized mafic rocks); introducing the natural gas and the carbonate-forming reagent into a first reactor; contacting the natural gas and the carbonate-forming reagent in the first reactor for a sufficient time to form sweetened natural gas comprising a second amount of carbon dioxide lower than the first amount of carbon dioxide and a first aqueous slurry comprising a first carbonate precipitate; and collecting the sweetened natural gas from the first reactor.

### FIELD OF THE DISCLOSURE

The present disclosure relates generally to carbonate mineralization and, more particularly, to carbonate mineralization in reactors during natural gas processing.

### BACKGROUND OF THE DISCLOSURE

Natural gas often contains impurities such as carbon dioxide (CO₂). Removing carbon dioxide from the natural gas is often performed to improve the quality of natural gas, prevent corrosion, and reduce greenhouse gas emissions.

Common methods for removing carbon dioxide from natural gas include, for example, amine absorption, distillation, and membrane separation, but these methods may be problematic in various respects. Membranes may require large amounts of energy due to the high pressure needed to drive the CO₂ through the membrane. Additionally, high quality membranes are often expensive, and membranes may accumulate unwanted material over time. Distillation processes using aqueous amine solution scrubbing also utilize high amounts of energy, which makes such processes economically challenging, and there may be limited selectivity for removing CO₂ in this manner. The corrosive nature of aqueous amine solutions can lead to significant maintenance costs for this technique of CO₂ removal. Additionally, amine absorption frequently has limited efficiency in high-concentration CO₂ streams.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, methods for natural gas sweetening comprise: providing natural gas comprising a first amount of carbon dioxide; selecting a carbonate-forming reagent based on the first amount of carbon dioxide in the natural gas, wherein the carbonate-forming reagent comprises a high-CO₂ reagent or a low-CO₂ reagent; introducing the natural gas and the carbonate-forming reagent into a first reactor; contacting the natural gas and the carbonate-forming reagent in the first reactor for a sufficient time to form sweetened natural gas comprising a second amount of carbon dioxide which is lower than the first amount of carbon dioxide and a first aqueous slurry comprising a first carbonate precipitate; and collecting the sweetened natural gas from the first reactor. The high-CO₂ reagent comprises an alkaline aqueous fluid comprising calcium ions, and the low-CO₂ reagent comprises an aged aqueous fluid comprising pulverized ultramafic rocks, pulverized mafic rocks, or any combination thereof.

In other embodiments, methods for natural gas sweetening comprise: providing natural gas comprising a first amount of carbon dioxide; providing a high-CO₂ reagent comprising an alkaline aqueous fluid comprising calcium ions and having a pH of about 11.9 to about 13.9; introducing the natural gas and the high-CO₂ reagent into a first reactor; contacting the natural gas and the high-CO₂ reagent in the first reactor for a sufficient time to form sweetened natural gas comprising a second amount of carbon dioxide which is lower than the first amount of the carbon dioxide and a first aqueous slurry comprising CaCO₃; and optionally, introducing the sweetened natural gas into a second reactor, and contacting the sweetened natural gas with a fresh carbonate-forming reagent to form further sweetened natural gas comprising a third amount of carbon dioxide which is lower than the second amount of carbon dioxide. Ca(OH)₂, CaCl₂, or any combination thereof is dispersed in the alkaline aqueous fluid.

In still other embodiments, methods for natural gas sweetening comprise: providing natural gas comprising a first amount of carbon dioxide; providing a low-CO₂ reagent comprising an aged aqueous fluid comprising pulverized ultramafic rocks, pulverized mafic rocks, or any combination thereof and having a pH of about 8.3 to about 10.3; introducing the natural gas and the low-CO₂ reagent into a first reactor; contacting the natural gas and the low-CO₂ reagent in the first reactor for a sufficient time to form sweetened natural gas comprising a second amount of carbon dioxide which is lower than the first amount of the carbon dioxide and a first aqueous slurry comprising a first carbonate precipitate; and optionally, introducing the sweetened natural gas and fresh low-CO₂ reagent into a second reactor, and contacting the sweetened natural gas and the fresh low-CO₂ reagent in the second reactor to form further sweetened natural gas comprising a third amount of carbon dioxide which is lower than the second amount of carbon dioxide and a second aqueous slurry comprising a second carbonate precipitate. The first carbonate precipitate comprises a carbonate selected from the group consisting of FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), and any combination thereof.

Any combinations of the various embodiments and implementations disclosed herein can be used in a further embodiment, consistent with the disclosure. These and other aspects and features can be appreciated from the following description of certain embodiments presented herein in accordance with the disclosure and claims.

### BRIEF DESCRIPTION OF THE DRAWINGS

Not applicable.

### DETAILED DESCRIPTION

Embodiments in accordance with the present disclosure generally relate to carbonate mineralization and, more particularly, to carbonate mineralization in reactors during natural gas processing.

Conventional approaches for removing carbon dioxide from natural gas may be energy intensive and exhibit other shortcomings. An advantageous alternative to these conventional approaches is direct CO₂ mineralization. Direct CO₂ mineralization does not require an intermediate step of CO₂ separation, but instead directly converts CO₂ in natural gas into at least one carbonate-containing mineral. This approach may be more cost effective and energy efficient than conventional CO₂ removal techniques. Performing direct CO₂ mineralization in a reactor offers additional benefits such as controlling the reaction environment (e.g., pressure, temperature, humidity, and the like) in order to optimize the reaction efficiency. As described herein, various low-cost materials may be utilized as a carbonate-forming reagent. Additionally, depending on the amount of CO₂ in the natural gas, as well as the carbonate-forming reagent that is used, economically valuable carbonate-containing precipitates may be obtained. In the case of natural gas containing CO₂ below a threshold amount, low-value ultramafic and mafic rocks may be utilized as the carbonate-forming reagent.

Methods of the present disclosure may be performed in a reactor. By performing direct CO₂ mineralization in a reactor, controlled reaction conditions may be realized. This approach may be advantageous compared to CO₂ mineralization occurring within a subterranean formation in an uncontrolled environment. The reactor may have a controlled and managed environment, including temperature and pressure, unlike CO₂ mineralization taking place in a subterranean formation under uncontrolled conditions. The reactor(s) in which CO₂ mineralization takes place may be at a surface location (i.e. not underground in subterranean formations). The reactor may directly and/or indirectly receive natural gas from a subterranean formation, such as via a wellbore that extends into a subterranean formation.

Methods for mineralizing CO₂ in natural gas processing may comprise: providing natural gas comprising a first amount of carbon dioxide (CO₂) based on a total mass of the natural gas; and selecting a carbonate-forming reagent based on the first amount of carbon dioxide in the natural gas, wherein the carbonate-forming reagent may comprise a high-CO₂ reagent, or a low-CO₂ reagent, or any combination thereof. The natural gas and the carbonate-forming reagent may be introduced into the first reactor, and the natural gas may be contacted with the carbonate-forming reagent in the first reactor for a sufficient time to form a first aqueous slurry comprising a first carbonate precipitate and to form sweetened natural gas comprising a second amount of carbon dioxide which is lower than the first amount of carbon dioxide. The sweetened natural gas may be collected from the first reactor and may optionally undergo further sweetening in a second reactor, as discussed further herein.

In non-limiting examples, at least the first reactor may be a batch reactor or a continuous reactor. The carbonate-forming reagent may be dispersed in a fluid when processing carbon dioxide in the first reactor according to the disclosure herein.

The natural gas may originate from subsurface geological formations, shale deposits, gas fields, landfills, commercially available sources, or any combination thereof. Alternately, the natural gas may be received from a natural gas processing facility, such as a natural gas liquefaction facility or a natural gas regasification facility.

Natural gas comprises predominantly methane and CO₂ impurities, as well as additional impurities such as higher alkanes (natural gas liquids), hydrogen sulfide (H₂S), nitrogen gas (N₂), water vapor, and the like. At least a portion of the additional impurities may be separated from the natural gas through known techniques before performing the methods described herein. Alternately, the natural gas may be processed to remove carbon dioxide according to the disclosure herein without previously removing the additional impurities.

Suitable carbonate-forming reagents may be easily obtained and inexpensively sourced. The carbonate-forming reagents may be used to treat a wide range of CO₂ concentrations in natural gas. The carbonate-forming reagents may be selected based upon the amount of carbon dioxide that is present in the natural gas. Depending on the amount of carbon dioxide in the natural gas, either a high-CO₂ reagent or a low-CO₂ reagent may be selected, as defined further herein. Appropriate threshold amounts of carbon dioxide and other considerations to merit use of a particular carbonate-forming reagent or type of carbonate-forming reagent are discussed further below.

Providing (or supplying) the natural gas may include determining a percentage of CO₂ in the natural gas using a gas analyzer. Accordingly, methods of the present disclosure may further comprise: assessing a percentage of CO₂ in the natural gas with a gas analyzer. Suitable gas analyzers may include infrared (IR) gas analyzers, electrochemical gas analyzers, gas chromatography (GC) analyzers, ultraviolet (UV) gas analyzers, thermal conductivity gas analyzers (TCD), chemiluminescence analyzers, non-dispersive infrared (NDIR) gas analyzers, laser-based gas analyzers, electromagnetic (EM) gas analyzers, mass spectrometry gas analyzers, or any combination thereof.

The amount of carbon dioxide in the natural gas (i.e., the first amount of carbon dioxide) may be about 44 wt % or below, based on total mass of the natural gas. The amount of carbon dioxide in the natural gas may range from about 1 wt % to about 44 wt %, or about 2 wt % to about 40 wt %, or about 3 wt % to about 35 wt %, or about 4 wt % to about 30 wt %, or about 5 wt % to about 25 wt %, or about 6 wt % to about 20 wt %, or about 8 wt % to about 18 wt %, or about 10 wt % to about 15 wt %, or about 12 wt % to about 20 wt %, based on the total mass of the natural gas.

The threshold amount may be set to 10% based on total mass of the natural gas. If the natural gas comprises at least 10% carbon dioxide based on total mass, a high-CO₂ reagent may be selected; and/or if the natural gas comprises less than 10% carbon dioxide based on total mass, a low-CO₂ reagent may be selected.

Although a threshold amount of 10% may represent a convenient break point between the high-CO₂ reagents and low-CO₂ reagents disclosed herein, it is to be appreciated that other threshold amounts may be suitably used in some cases.

Alternately, the threshold amount between selecting the high-CO₂ reagent and a low-CO₂ reagent may be fixed at value other than 10% based on total mass of the natural gas. For example, the threshold amount may be fixed at a lower value of about 9%, 8%, 7%, 6%, 5%, 4%, 3%, 2%, or 1%, with the high-CO₂ reagent being selected at or above the threshold amount and the low-CO₂ reagent being selected below the threshold amount. Alternately, the threshold amount may be fixed at a higher value of about 11%, 12%, 13%, 14%, 15%, 16%, 17%, 18%, 19%, 20%, 21%, 22%, 23%, 24%, or 25%. The threshold amount may be selected by the user as desired.

The natural gas may be supplied to the first reactor under a range of conditions. Contacting the natural gas with the carbonate-forming reagent in the first reactor may occur under such conditions or under different conditions.

The natural gas may be introduced to the first reactor at a feed pressure of at least about 30 bar, such as about 30 bar to about 60 bar, or about 35 bar to about 55 bar, or about 40 bar to about 50 bar, or about 42 bar to about 47 bar.

Partial depressurization may occur during introduction of the natural gas into the first reactor, thereby giving a reaction pressure lower than the feed pressure. Contacting of the natural gas with the carbonate-forming reagent in the first reactor may take place at a reaction pressure of at least about 1 bar, or at least about 5 bar, or at least about 30 bar, or at least about 50 bar. In non-limiting examples, contacting may occur at a reaction pressure of about 1 bar to about 60 bar, or about 2 bar to about 55 bar, or about 3 bar to about 50 bar, or about 4 bar to about 40 bar, or about 5 bar to about 30 bar, or about 10 bar to about 20 bar.

The natural gas may be introduced to the first reactor and/or contacting may take place in the first reactor at a temperature of at least about 25 °C, or at least about 50 °C, or at least about 70 °C, or at least about 100 °C. In non-limiting examples, the temperature of the natural gas introduced to the first reactor may be at a temperature of about 25 °C to about 125 °C, or about 35 °C to 110 °C, or about 40 °C to about 100 °C, or about 50 °C to about 90 °C, or about 60 °C to about 80 °C, or about 65 °C to about 70 °C. In some or other non-limiting examples, contacting the natural gas with the carbonate-forming reagent in the first reactor may take place at a temperature of about 25 °C to about 125 °C, or about 35 °C to 110 °C, or about 40 °C to about 100 °C, or about 50 °C to about 90 °C, or about 60 °C to about 80 °C, or about 65 °C to about 70 °C.

In non-limiting examples, contacting the natural gas with the carbonate-forming reagent may take place at about 37 °C and/or up to about 60 bar.

Introducing the natural gas into the first reactor may occur at a rate of about 0.1 mol/min or above, such as about 0.1 mol/min to about 0.5 mol/min, or about 0.2 mol/min to about 0.4 mol/min, or about 0.3 mol/min to about 0.38 mol/min, or about 0.33 mol/min to about 0.35 mol/min. For example, introducing the natural gas into the first reactor may occur at a rate of about 0.33 mol/min.

Introducing the carbonate-forming reagent into the first reactor may occur at a rate of about 0.1 mol/min or above, such as about 0.1 mol/min to about 0.5 mol/min, or about 0.2 mol/min to about 0.4 mol/min, or about 0.3 mol/min to about 0.38 mol/min, or about 0.33 mol/min to about 0.35 mol/min. For example, introducing the carbonate-forming reagent into the first reactor may occur at a rate of about 0.33 mol/min.

The natural gas and the carbonate-forming reagent may be introduced together or separately. If introduced separately (sequentially), introduction of the natural gas may occur either before or after the carbonate-forming reagent.

Contacting the natural gas with the carbonate-forming reagent may take place for a sufficient time to decrease the amount of carbon dioxide in the natural gas to a desired degree. In non-limiting examples, contacting may take place for at least about 1 minute, or at least about 2 minutes, or at least about 5 minutes, or at least about 10 minutes, or at least about 15 minutes, or at least about 18 minutes, or at least about 30 minutes, or at least about 1 hour, or at least about 2 hours, such as about 1 minute to about 3 hours, or about 2 minutes to about 2.5 hours, or about 5 minutes to about 2 hours, or about 10 minutes to about 1.5 hours, or about 15 minutes to about 1 hour, or about 20 minutes to about 45 minutes, or about 30 minutes to about 40 minutes.

In some additional or alternative examples, contacting may take place until a specified amount of carbon dioxide has been removed from the natural gas. For instance, contacting may take place until at least about 50%, or at least about 60%, or at least about 70%, or at least about 80%, or at least about 90%, or at least about 95%, or at least about 98%, or at least about 99%, or substantially all of the carbon dioxide has been removed from the natural gas. Contacting may also take place until a carbon dioxide absorption capacity of the carbonate-forming reagent has been exhausted.

Other impurities may be removed from the natural gas as well, either before or after performing the methods described herein. For example, impurities such as hydrogen sulfide (H₂S) and/or nitrogen (N₂) may be removed from the natural gas. H₂S may be removed by a H₂S removal process such as, for example, an absorption process, the Claus process, an iron sponge process, a zinc oxide (ZnO) process, a biofilter process, or any combination thereof. Suitable absorbents for absorption processes may include amines, activated carbon, molecular sieves, and any combination thereof. Nitrogen removal may be accomplished by, for example, cryogenic distillation, pressure swing adsorption (PSA), membrane separation, molecular sieve absorption, vacuum swing adsorption (VSA), or any combination thereof. When performed, removal of H₂S and nitrogen from the natural gas may occur simultaneously or sequentially.

The carbonate-forming reagent may produce carbonates through one or more carbonation reactions. Not being limited by theory, examples of carbonation reactions may include those shown in Reactions 1-8 below.

CO₃⁻²+Ca⁺² [symbol] CaCO₃ (calcite) Reaction 1

Fe⁺²+CO₃⁻² [symbol] FeCO₃ (siderite) Reaction 2

Mg⁺²+CO₃⁻² [symbol] MgCO₃ (magnesite) Reaction 3

Ca⁺²+Fe⁺²+2CO₃⁻² [symbol] (Caₓ, Fe_{y})(CO₃)₂ (ankerite) Reaction 4
where x+y=2

Ca⁺²+Mg⁺²+2CO₃⁻² [symbol] (Caₓ, Mg_{y})(CO₃)₂ (ankerite) Reaction 5

where x+y=2

Ca⁺²+Fe⁺²+Mg⁺²+2CO₃⁻² [symbol] (Caₓ, Fe_{y}, Mg_{z})(CO₃)₂, (ankerite) Reaction 6
where x+y+z=2

HCO₃⁻+Mg⁺²+3H₂O [symbol] MgCO₃·3H₂O (nesquehonite)+H⁺ Reaction 7

4HCO₃⁻+5Mg⁺²+6H₂O [symbol] Mg₅(CO₃)₄(OH)₂·4H₂O (hydromagnesite)+6H⁺ Reaction 8

The high-CO₂ reagent may comprise an alkaline aqueous fluid comprising calcium ions. The calcium ions may originate from a calcium salt dispersed (and/or dissolved and/or suspended) in the aqueous fluid. For example, the high-CO₂ reagent may comprise calcium hydroxide (Ca(OH)₂), calcium chloride (CaCl₂), calcium brine, or any combination thereof dispersed in the alkaline aqueous fluid; wherein the calcium brine is produced from calcium brine modified with the addition of a base such as KOH, NaOH, Ca(OH)₂, or any combination thereof. The addition of the base to the calcium brine or the aqueous fluid is to increase the pH of the high-CO₂ reagent to desired ranges. Calcium hydroxide is also known as slaked lime or portlandite or E526. Limewater, also known as milk of lime, is the common name for saturated aqueous calcium hydroxide.

The high-CO₂ reagent may have a pH of about 11.0 to about 13.9 or about 11.9 to about 13.9, such as about 12 to about 13.8, or about 12.2 to about 13.5, or about 12.3 to about 13.4, or about 12.4 to about 13.3, or about 12.5 to about 13.2, or about 12.6 to about 13.1, or about 12.7 to about 13, or about 12.8 to about 12.9. The foregoing represent room temperature pH values. The pH values may be affected by the temperature; as the temperature falls, the pH rises. Hence, the pH value during contacting may differ somewhat from the as-provided pH value of the high-CO₂ reagent.

Calcium ions may be present in the alkaline aqueous fluid of the high-CO₂ reagent at a concentration of about 1 mol/kgw (kilograms of water) to about 4 mol/kgw, such as about 1.6 mol/kgw to about 3.8 mol/kgw, or about 1.8 mol/kgw to about 3.6 mol/kgw, or about 2 mol/kgw to about 3.4 mol/kgw, or about 2.2 mol/kgw to about 3.2 mol/kgw, or about 2.3 mol/kgw to about 3 mol/kgw, or about 2.4 mol/kgw to about 2.8 mol/kgw, or about 2.5 mol/kgw to about 2.6 mol/kgw, or about 2.2 mol/kgw (kilograms of water). Alternately, the calcium ions in the alkaline aqueous fluid may be present at a concentration of about 0.01 M (molar, moles per liter) to about 5 M, such as about 0.1 M to about 4 M, or about 0.5 M to about 3.9 M, or about 1 M to about 3.8 M, or about 1.6 M to about 3.7 M, or about 1.8 M to about 3.6 M, or about 2 M to about 3.4 M, or about 2.2 M to about 3.2 M, or about 2.3 M to about 3 M, or about 2.4 M to about 2.8 M, or about 2.5 M to about 2.6 M, or about 2.2 M.

Additionally or alternately, the alkaline aqueous fluid comprising calcium ions may originate from a source such as, for example, calcium brine from salt lakes, calcium brine from ground water, calcium brine from oil or gas production, or any combination thereof. Having such high-CO₂ reagents or components used in producing a high-CO₂ reagent near a natural gas processing facility can lower transportation costs associated with providing the high-CO₂ reagent.

The first carbonate precipitate may comprise CaCO₃ and be obtained as a first aqueous slurry in the first reactor. The CaCO₃ may comprise micron-size CaCO₃, nano-size CaCO₃, or any combination thereof. The CaCO₃ may comprise vaterite (μ-CaCO₃), aragonite, calcite, or any combination thereof. Limestone comprises a combination of aragonite and calcite.

When using the high-CO₂ reagent, the first aqueous slurry may include various quantities of CaCO₃. Loadings of CaCO₃ in the first aqueous slurry may range from about 0.01 wt % to about 99.99 wt %, based on total mass of the first aqueous slurry. In non-limiting examples, the loading of CaCO₃ in the first aqueous slurry may range from about 5 wt % to about 95 wt %, or about 10 wt % to about 90 wt %, or about 20 wt % to about 80 wt %, or about 30 wt % to about 70 wt %, or about 40 wt % to about 60 wt %, or about 50 wt % to about 55 wt %, based on total mass of the first aqueous slurry.

After removal of carbon dioxide from the natural gas has been completed to a sufficient degree, the first aqueous slurry may be removed from the first reactor. For example, the first aqueous slurry may be drained from the first reactor. The CaCO₃ may then be collected from the first aqueous slurry, such as by filtration, decantation, centrifugation, or the like. The residual aqueous fluid obtained from the first aqueous slurry may be discarded or undergo further treatment and/or reused in carbonate-forming reagents.

The CaCO₃ obtained from the first aqueous slurry has economic value and may be sold as a product stream. Alternately, the CaCO₃ may be utilized in at least one commercial process. Optionally, the CaCO₃ may undergo further processing such as drying, crushing, pulverizing, and the like. Suitable commercial processes or uses for CaCO₃ may include, for example, cement, animal feed, fertilizer, soil amendments, coatings, fillers, paints, pharmaceuticals, food additives, calcium supplements, water treatment, exfoliants in skin care, abrasives in toothpaste, glass making, the like, or any combination thereof.

When the natural gas contains carbon dioxide below a threshold amount, the low-CO₂ reagent may be used instead. The low-CO₂ reagent may comprise an aged aqueous fluid comprising pulverized endogenic rocks (i.e., pulverized ultramafic rocks and/or pulverized mafic rocks). Because there is less carbon dioxide to capture, there is less impetus to obtain a single carbonate precipitate, such as the CaCO₃ produced using the high-CO₂ reagent. As such, pulverized endogenic rocks may be utilized as the source of calcium ions.

The low-CO₂ reagent may have a pH of about 8.3 to about 10.3, such as about 8.4 to about 10.2, or of about 8.6 to about 10, or of about 8.8 to about 9.8, or of about 8.9 to about 9.7, or of about 9.0 to about 9.6, or of about 9.1 to about 9.5, or of about 9.2 to about 9.4, or of about 9.25 to about 9.3. The foregoing represent room temperature pH values. The pH values may be affected by the temperature; as the temperature falls, the pH rises. Hence, the pH value during contacting may differ somewhat from the as-provided pH value of the low-CO₂ reagent.

The low-CO₂ reagent may comprise an aged aqueous fluid comprising pulverized ultramafic rocks, pulverized mafic rocks, or any combination thereof. The minerals in pulverized ultramafic rocks and pulverized mafic rocks are only slowly soluble in aqueous fluids. Hence, aging is performed to allow a sufficient quantity of calcium ions to build in the aqueous fluid of the low-CO₂ reagent over time. The aged aqueous fluid may be aged for at least about 1 month, or at least about 2 months, or at least about 6 months, or at least about 1 year, or at least about 2 years. In non-limiting examples, the aged aqueous fluid may be aged for about 1 month to about 5 years, or about 2 months to about 4 years, or about 3 months to about 3 years, or about 4 months to about 2.5 years, or about 5 months to about 2 years, or about 6 months to about 1.5 years, or about 9 months to about 1 year.

Pulverizing may comprise grinding, crushing, milling, or any combination thereof. After pulverizing, the pulverized ultramafic rocks and/or pulverized mafic rocks may be at most about 1 mm (1,000 μm) in particle size, or at most about 0.5 mm (500 μm) in particle size, or at most about 0.1 mm (100 μm) in particle size. After pulverizing, the pulverized ultramafic rocks and/or pulverized mafic rocks may be about 0.001 mm (1 μm) to about 1 mm (1000 μm) in particle size, or about 0.01 mm (10 μm) to about 0.8 mm (800 μm) in particle size, or about 0.1 mm (100 μm) to about 0.5 mm (500 μm) in particle size.

During the aging process, the aged aqueous fluid may be stirred either continuously or occasionally. During the aging process, the aged aqueous fluid may be heated either continuously or occasionally. When performed, heating may take place at a temperature above room temperature to about 55 °C, or at about 30 °C to about 50 °C, or at about 40 °C to about 35 °C.

During the aging process, a dissolution-promoting agent may be added to the aged aqueous fluid in order to increase the rate of dissolution. Suitable dissolution-promoting agents may include, for example, NaCl, KCl, citric acid, CaCl₂, Ca(OH)₂, MgCl₂, Mg(OH)₂, NaOH, KOH, tannins, acetic acid, or any combination thereof. When used, the dissolution-promoting agent may be included in the aged aqueous fluid in a concentration of about 0.001 M to about 2 M, or about 0.01 M to about 1.5 M, or about 0.05 M to about 1 M, or about 0.1 M to about 0.7 M, or about 0.3 M to about 0.5 M.

The low-CO₂ reagent may include pulverized ultramafic rocks, the pulverized mafic rocks, or any combination thereof. Suitable pulverized mafic and ultramafic rocks may include pulverized pyroxenes, pulverized forsterites (Mg₂SiO₄), pulverized labradorites, or any combination thereof. Pyroxenes are represented by the formula (Ca,Na,Fe,Mg,Zn,Mn,Li) (Cr,Al,Mg,Co,Mn,Sc,Ti,V,Fe)(Si,Al)₂O₆ and/or by the formula (Mg,Fe)SiO₃. Non-limiting examples of suitable pyroxenes may include diopside (CaMgSi₂O₆), spodumene (LiAlSi₂O₆, LiAl(SiO₃)₂), and/or hedenbergite (CaFeSi₂O₆). Labradorites are represented by the formula NaₓCa_{y}AlₐSi_{b}O₈, where x+y=1 and a+b=4, and where x is usually about 0.3 to about 0.5 and y is usually about 0.5 to about 0.7.

Dissolution reactions associated with the minerals in mafic and ultramafic rocks may include, but are not limited to, those shown in Reactions 9-12 below.

Mg₂SiO₄ (forsterite)+4H⁺ [symbol] 2H₂O+SiO₂+2Mg⁺² Reaction 9

Fe₂SiO₄ (fayalite)+4H⁺ [symbol] 2H₂O+SiO₂+2Fe⁺² Reaction 10

CaMgSi₂O₆ (diopside)+4H⁺ [symbol] 2H₂O+SiO₂+2Mg⁺²+2Ca⁺² Reaction 11
Reaction 12: NaₓCa_{y}AlₐSi_{b}O₈ (labradorite)+3.2H₂O [symbol] 0.4Na⁺¹+0.6Ca+1.6Al(OH)₄+2.4SiO₂, where x+y=1 and a+b=4, and where x is usually about 0.3 to about 0.5 and y is usually about 0.5 to about 0.7; or any combination thereof.

In addition to the pulverized mafic or ultramafic rocks, the low-CO₂ reagent may further comprise an additive. Suitable additives may include CaCl₂, Ca(OH)₂, or any combination thereof. The additive may aid in increasing the reactivity of the low-CO₂ reagent to promote formation of the first carbonate precipitate.

The first carbonate precipitate produced from the low-CO₂ reagent may comprise one or more minerals. Minerals produced from the low-CO₂ reagent may include, for example, FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), amorphous silica, smectites, phyllosilicates, serpentines ((Mg,Fe)₃Si₂O₅(OH)₄), Si₂O₅ minerals, quartz (SiO₂), corundum (Al₂O₃), gibbsites (Al(OH)₃), hematites (Fe₂O₃), or any combination thereof. Multiple minerals are commonly produced in combination when using the low-CO₂ reagent.

When using the low-CO₂ reagent, the first aqueous slurry may include various quantities of minerals produced from the mafic or ultramafic rocks. Loadings of the first carbonate precipitate in the first aqueous slurry may range from about 0.01 wt % to about 99.99 wt %, based on total mass of the first aqueous slurry. In non-limiting examples, the loading of the first carbonate precipitate in the first aqueous slurry may range from about 5 wt % to about 95 wt %, or about 10 wt % to about 90 wt %, or about 20 wt % to about 80 wt %, or about 30 wt % to about 70 wt %, or about 40 wt % to about 60 wt %, or about 50 wt % to about 55 wt %, based on total mass of the first aqueous slurry.

After removal of carbon dioxide from the natural gas has been completed to a sufficient degree using the low-CO₂ reagent, the first aqueous slurry may be removed from the first reactor. For example, the first aqueous slurry may be drained from the first reactor. The first carbonate precipitate may then be collected from the first aqueous slurry, such as by filtration, decantation, centrifugation, or the like. The residual aqueous fluid obtained from the first aqueous slurry may be discarded or undergo further treatment and/or reused in carbonate-forming reagents.

The first carbonate precipitate obtained from the first aqueous slurry when using the low-CO₂ reagent may be more complex than that produced using the high-CO₂ reagent. Nevertheless, the first carbonate precipitate obtained from the low-CO₂ reagent still has economic value and may be optionally utilized in at least one commercial process. Optionally, the first carbonate precipitate may undergo further processing such as drying, crushing, pulverizing, and the like. Suitable commercial processes or uses for the first carbonate precipitate may include, for example, fertilizers, fillers, cementitious materials, or any combination thereof. The filler materials may be used for open pits in the mining industry, as a filler for voids in construction, soil amendments, erosion control, land reclamation, the like, or any combination thereof.

Contacting of the natural gas and the carbonate-forming reagent may take place in a single reactor or multiple reactors in series and/or parallel. In some examples, contacting may take place in at least two reactors in series. The carbonate-forming reagent in the at least two reactors may be the same or different. In some example, first and second reactors of the at least two reactors may each contain a high-CO₂ reagent or a low-CO₂ reagent. In other examples, a first reactor of the at least two reactors may contain a high-CO₂ reagent and a second of the at least two reactors may contain a low-CO₂ reagent.

Optionally, removal of carbon dioxide from the natural gas may take place in multiple reactors in series. When using a second or subsequent reactor, methods of the present disclosure may further comprise: introducing the sweetened natural gas and a fresh carbonate-forming reagent into the second reactor, contacting the sweetened natural gas and the fresh carbonate-forming reagent for sufficient time to form further sweetened natural gas and a second aqueous slurry comprising a second carbonate precipitate, and collecting the further sweetened natural gas from the second reactor. The further sweetened natural gas contains a third amount of carbon dioxide that is lower than the second amount of carbon dioxide. The fresh carbonate-forming reagent may be the same as or different than the carbonate-forming reagent used in the first reactor. In some examples, a high-CO₂ reagent may be utilized in the first reactor, and a low-CO₂ reagent may be utilized in the second reactor.

By sequentially treating the natural gas in a first reactor and a second reactor, extensive removal of carbon dioxide may take place. In non-limiting examples, the third amount of CO₂ may be about 2 wt % or less, or about 1.8 wt % or less, or about 1.5 wt % or less, or about 1 wt % or less, or about 0.8 wt % or less, or about 0.6 wt % or less, or about 0.5 wt % or less, based on total mass of the natural gas, such as about 0.001 wt % to about 2 wt %, or about 0.005 wt % to about 1.8 wt %, or about 0.01 wt % to about 1.5 wt %, or about 0.1 wt % to about 1.3 wt %, or about 0.3 wt % to about 1 wt %, or about 0.3 wt % to about 0.8 wt %, based on total mass of the natural gas.

Geochemical modeling may be further utilized in conjunction with the natural gas sweeting methods described herein. The geochemical modeling may include reaction path modeling to assist in design of the methods for removing carbon dioxide from the natural gas. For example, reaction path modeling may be utilized to determine mass transfer between various phases with a reaction system and/or determine whether incremental increases or decreased in amounts of reagents are warranted. Parameters associated with reaction path modeling may include, but are not limited to, temperature, pressure, pH, salinity, total dissolved solids, total carbon dioxide within the natural gas, and the like. Such parameters may be determined using various types of sensors within at least the first reactor and/or in the natural gas being provided to the first reactor. The reaction path modeling may be utilized to determine, for example, time-dependent concentrations of carbon dioxide and/or carbonate-forming reagent in the first reactor, which may be utilized for facilitating process management and adjustment.

Methods for producing sweetened natural gas and CaCO₃ may comprise: providing natural gas comprising a first amount of carbon dioxide (e.g., at least about 10% carbon dioxide, based on total mass); providing a high-CO₂ reagent comprising calcium ions and having a pH of about 11.9 to about 13.9; introducing the natural gas and the high-CO₂ reagent into a first reactor; contacting the natural gas and the high-CO₂ reagent in the first reactor for a sufficient time to form a sweetened natural gas comprising a second amount of carbon dioxide which is lower than the first amount of carbon dioxide and a first aqueous slurry comprising CaCO₃. Ca(OH)₂, CaCl₂, or any combination thereof may be dispersed in the alkaline aqueous fluid. Optionally, the sweetened natural gas may be introduced into a second reactor and contacted with a fresh carbonate-forming reagent to form further sweetened natural gas comprising a third amount of carbon dioxide which is lower than the second amount of carbon dioxide.

Methods for producing sweetened natural gas using a low-CO₂ reagent may comprise: providing natural gas comprising a first amount of carbon dioxide (e.g. less than 10% carbon dioxide, based on total mass); providing a low-CO₂ reagent comprising an aged aqueous fluid comprising pulverized ultramafic rocks, pulverized mafic rocks, or any combination thereof and having a pH of about 8.3 to about 10.3; introducing the natural gas and the low-CO₂ reagent into a first reactor; and contacting the natural gas and the low-CO₂ reagent in the first reactor for a sufficient time to form sweetened natural gas comprising a second amount of carbon dioxide which is lower than the first amount of the carbon dioxide and a first aqueous slurry comprising a first carbonate precipitate. The first carbonate precipitate comprises a carbonate such as, for example, FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), or any combination thereof. Optionally, the sweetened natural gas and fresh low-CO₂ reagent may be introduced into a second reactor and contacted with each other to form further sweetened natural gas comprising a third amount of carbon dioxide which is lower than the second amount of carbon dioxide and a second aqueous slurry comprising a second carbonate precipitate.

The methods of the present disclosure may further comprise purifying the sweetened natural gas to generate sales gas. In non-limiting examples, further purification of the sweetened natural gas may include dehydrating the sweetened natural gas to remove trace water, additional acid gas removal, or any combination thereof. For example, there may be a limit on the amount of hydrogen sulfide present (typically on the order of about 10 parts per million) and the amount of carbon dioxide (typically around 2 mole percent) in sales gas.

In some examples, CO₂ from an external source may be added to the natural gas. Doing so may allow the high-CO₂ reagent to be selected when its use might not otherwise be warranted or feasible. Accordingly, in some examples, methods of the present disclosure may comprise adding carbon dioxide from an external source to the natural gas and/or the first reactor to increase the first amount of carbon dioxide over about 10%, based upon total mass. In doing so, the high-CO₂ reagent then may be selected for forming the first carbonate precipitate. For example, when the natural gas comprises about 10 wt % or less, or about 9 wt % or less, or about 8 wt % or less, or about 7 wt % or less carbon dioxide, external carbon dioxide may be introduced to increase the total amount of carbon dioxide above about 10 wt %. In some cases, this approach may promote more effective removal of carbon dioxide from the natural gas. In non-limiting examples, the CO₂ from an external source may originate from industrial processes, commercial processes, fossil fuel combustion, air capture (DAC), organic matter decomposition (i.e., landfill gas), or any combination thereof.

The present disclosure is further directed to the following non-limiting embodiments:

Embodiment 1. A method comprising: providing natural gas comprising a first amount of carbon dioxide; selecting a carbonate-forming reagent based on the first amount of carbon dioxide in the natural gas, wherein the carbonate-forming reagent comprises a high-CO₂ reagent or a low-CO₂ reagent; wherein the high-CO₂ reagent comprises an alkaline aqueous fluid comprising calcium ions, and the low-CO₂ reagent comprises an aged aqueous fluid comprising pulverized ultramafic rocks, pulverized mafic rocks, or any combination thereof; introducing the natural gas and the carbonate-forming reagent into a first reactor; contacting the natural gas and the carbonate-forming reagent in the first reactor for a sufficient time to form sweetened natural gas comprising a second amount of carbon dioxide which is lower than the first amount of carbon dioxide and a first aqueous slurry comprising a first carbonate precipitate; and collecting the sweetened natural gas from the first reactor.

Embodiment 2. The method of embodiment 1, wherein the natural gas comprises at least 10% carbon dioxide based on total mass, and the high-CO₂ reagent is selected.

Embodiment 3. The method of embodiment 1, wherein the natural gas comprises less than 10% carbon dioxide based on total mass, the method further comprising: adding CO₂ from an external source to the natural gas and/or the first reactor to increase the first amount of CO₂ to over 10% based on total mass; wherein the high-CO₂ reagent is selected.

Embodiment 4. The method of any one of embodiments 1-3, wherein the high-CO₂ reagent has a pH of about 11.9 to about 13.9.

Embodiment 5. The method of any one of embodiments 1-4, wherein the high-CO₂ reagent comprises Ca(OH)₂, CaCl₂, calcium brine, or any combination thereof dispersed in the alkaline aqueous fluid.

Embodiment 6. The method of any one of embodiments 1-5, wherein the first carbonate precipitate comprises CaCO₃.

Embodiment 7. The method of embodiment 6, further comprising: removing the first aqueous slurry from the first reactor; collecting the CaCO₃ from the first aqueous slurry; and optionally, utilizing the CaCO₃ in at least one commercial process.

Embodiment 8. The method of embodiment 1, wherein the natural gas comprises less than 10% carbon dioxide based on total mass, and the low-CO₂ reagent is selected.

Embodiment 9. The method of embodiment 1 or embodiment 8, wherein the low-CO₂ reagent has a pH of about 8.3 to about 10.3.

Embodiment 10. The method of any one of embodiments 1, 8, or 9, wherein the low-CO₂ reagent is aged for at least about 1 month before contacting the natural gas.

Embodiment 11. The method of any one of embodiments 1 or 8-10, wherein the low-CO₂ reagent further comprises an additive selected from the group consisting of CaCl₂, Ca(OH)₂, and any combination thereof.

Embodiment 12. The method of any one of embodiments 1 or 8-11, wherein the first carbonate precipitate comprises a carbonate selected from the group consisting of FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), and any combination thereof.

Embodiment 13. The method of embodiment 12, wherein the first carbonate precipitate further comprises at least one mineral selected from the group consisting of amorphous silica, smectites, phyllosilicates, serpentines ((Mg,Fe)₃Si₂O₅(OH)₄), Si₂O₅ minerals, quartz (SiO₂), corundum (Al₂O₃), gibbsites (Al(OH)₃), hematites (Fe₂O₃), and any combination thereof.

Embodiment 14. The method of embodiment 12 or embodiment 13, further comprising: removing the first aqueous slurry from the first reactor; collecting the first carbonate precipitate; and optionally, utilizing the first carbonate precipitate in at least one commercial process.

Embodiment 15. The method of any one of embodiments 1 or 8-14, wherein the pulverized ultramafic rocks and/or the pulverized mafic rocks comprise pyroxenes, forsterites (Mg₂SiO₄), fayalites (Fe₂SiO₄), labradorites, or any combination thereof.

Embodiment 16. The method of any one of embodiments 1-15, further comprising: introducing the sweetened natural gas and a fresh carbonate-forming reagent into a second reactor; contacting the sweetened natural gas and the fresh carbonate-forming reagent in the second reactor for a sufficient time to form further sweetened natural gas comprising a third amount of carbon dioxide which is lower than the second amount of carbon dioxide and a second aqueous slurry comprising a second carbonate precipitate; and collecting the further sweetened natural gas from the second reactor.

Embodiment 17. The method of embodiment 16, wherein the fresh carbonate-forming reagent is different than the carbonate-forming reagent.

Embodiment 18. The method of embodiment 16 or embodiment 17, wherein the fresh carbonate-forming reagent comprises the low-CO₂ reagent.

Embodiment 19. A method comprising: providing natural gas comprising a first amount of carbon dioxide (e.g., about 10%, based on total mass); providing a high-CO₂ reagent comprising an alkaline aqueous fluid comprising calcium ions and having a pH of about 11.9 to about 13.9; wherein Ca(OH)₂, CaCl₂, or any combination thereof is dispersed in the alkaline aqueous fluid; introducing the natural gas and the high-CO₂ reagent into a first reactor; contacting the natural gas and the high-CO₂ reagent in the first reactor for a sufficient time to form sweetened natural gas comprising a second amount of carbon dioxide which is lower than the first amount of the carbon dioxide and a first aqueous slurry comprising CaCO₃; and optionally, introducing the sweetened natural gas into a second reactor, and contacting the sweetened natural gas with a fresh carbonate-forming reagent to form further sweetened natural gas comprising a third amount of carbon dioxide which is lower than the second amount of carbon dioxide.

Embodiment 20. A method comprising: providing natural gas comprising a first amount of carbon dioxide (e.g., less than 10% based on total mass); providing a low-CO₂ reagent comprising an aged aqueous fluid comprising pulverized ultramafic rocks, pulverized mafic rocks, or any combination thereof and having a pH of about 8.3 to about 10.3; introducing the natural gas and the low-CO₂ reagent into a first reactor; contacting the natural gas and the low-CO₂ reagent in the first reactor for a sufficient time to form sweetened natural gas comprising a second amount of carbon dioxide which is lower than the first amount of the carbon dioxide and a first aqueous slurry comprising a first carbonate precipitate; wherein the first carbonate precipitate comprises a carbonate selected from the group consisting of FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), and any combination thereof; and optionally, introducing the sweetened natural gas and fresh low-CO₂ reagent into a second reactor, and contacting the sweetened natural gas and the fresh low-CO₂ reagent in the second reactor to form further sweetened natural gas comprising a third amount of carbon dioxide which is lower than the second amount of carbon dioxide and a second aqueous slurry comprising a second carbonate precipitate.

Embodiment 21. The method of any one of Embodiments 1-20, wherein reaction path modeling is utilized to alter the contacting of the natural gas and the carbonate-forming reagent in the first reactor.

### EXAMPLES

High-CO₂Natural Gas. In a prophetic example, a natural gas stream will be compressed to about 60 bar and a temperature of about 37 °C. The natural gas stream will contain about 20% of CO₂ and about 80% of CH₄, based on total mass of the natural gas stream.

The natural gas stream will be introduced into a reactor along with 1 kg of an aqueous fluid containing about 2 mol/kgw CaCl₂ and about 0.2 mol/kgw Ca(OH)₂ (kgw is kilograms of water). The pH of the aqueous fluid will be about 12.875. The rate of introduction of the natural gas stream into a reactor will be about 0.033 mol/min.

After about 0.3 hours of treatment, almost all of the CO₂ will be removed to yield near-pure CH₄. Carbon dioxide breakthrough will occur after about 1 hour of treatment. The alkalinity will be almost fully consumed after about 1.2 hours, after which the pH will drop to below 7. During about 1 hour, the high-CO₂ reagent will be able to neutralize about 2 moles of CO₂ (88 g) and will produce about 0.44 moles of CaCO₃ (44 g) per kg water. The postulated amount of CaCO₃ production is based on reaction path modeling rather than the molar amount of carbon dioxide being neutralized.

Low-CO₂ Natural Gas. In a prophetic example, a natural gas stream will be compressed to about 60 bar and a temperature of about 37 °C. The natural gas stream will contain about 8% of CO₂ and about 92% of CH₄, based on total mass of the natural gas stream.

Water (1 kg) will be mixed with 1 kg of pulverized olivine (70% forsterite and 30% fayalite) obtained from peridotite, and the mixture will be aged for about 1 year to generate sufficient alkalinity for CO₂ neutralization. Olivine is a magnesium iron silicate with the chemical formula (Mg,Fe)₂SiO₄. The final pH will be about 9.28 after about 1 year. About 0.1 mole (11.098 g) CaCl₂ per kg will be added to the water to increase the carbonate-mineral production. The alkalinity generated upon dissolution of the forsterite and fayalite will be about 1.27×10⁻⁴ meq/kg (milliequivalents per kg) water.

The natural gas stream will be introduced into a reactor along with 1 kg of the aged aqueous fluid prepared as above. The rate of introduction of the natural gas stream into a first reactor will be about 0.033 mol/min. The CO₂ concentration in the outflow from the reactor will quickly drop to about 4% and then will increase to about 7% at about 5 hours. Calcite precipitation will increase to about 0.09 moles/kg (or about 9 g/kg) at about 4 hours and then will remain constant.

Staged CO₂ Removal. In a prophetic example, reaction path modeling calculations suggest that the contact time for the first reactor may be about 1 hour, when the CO₂ concentration is about 4.4% based on total mass. After that, the natural gas will be introduced into a second reactor. After reacting for about 1 hour in the second reactor, the CO₂ concentration will decrease to about 2.5% based on total mass. The natural gas will then be introduced to a third reactor and after reacting for about 1 hour the CO₂ concentration will decrease to about 1.3% by total mass.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
providing natural gas comprising a first amount of carbon dioxide;
selecting a carbonate-forming reagent based on the first amount of carbon dioxide in the natural gas, wherein the carbonate-forming reagent comprises a high-CO₂ reagent or a low-CO₂ reagent;
wherein the high-CO₂ reagent comprises an alkaline aqueous fluid comprising calcium ions, and the low-CO₂ reagent comprises an aged aqueous fluid comprising pulverized ultramafic rocks, pulverized mafic rocks, or any combination thereof;
introducing the natural gas and the carbonate-forming reagent into a first reactor;
contacting the natural gas and the carbonate-forming reagent in the first reactor for a sufficient time to form sweetened natural gas comprising a second amount of carbon dioxide which is lower than the first amount of carbon dioxide and a first aqueous slurry comprising a first carbonate precipitate; and
collecting the sweetened natural gas from the first reactor.

2. The method of claim 1, wherein the natural gas comprises at least 10% carbon dioxide based on total mass, and the high-CO₂ reagent is selected.

3. The method of claim 1, wherein the natural gas comprises less than 10% carbon dioxide based on total mass, the method further comprising:
adding CO₂ from an external source to the natural gas and/or the first reactor to increase the first amount of CO₂ to over 10% based on total mass;
wherein the high-CO₂ reagent is selected.

4. The method of claim 1, wherein the high-CO₂ reagent has a pH of about 11.9 to about 13.9.

5. The method of claim 1, wherein the high-CO₂ reagent comprises Ca(OH)₂, CaCl₂, calcium brine, or any combination thereof dispersed in the alkaline aqueous fluid.

6. The method of claim 1, wherein the first carbonate precipitate comprises CaCO₃.

7. The method of claim 6, further comprising:
removing the first aqueous slurry from the first reactor;
collecting the CaCO₃ from the first aqueous slurry; and
optionally, utilizing the CaCO₃ in at least one commercial process.

8. The method of claim 1, wherein the natural gas comprises less than 10% carbon dioxide based on total mass, and the low-CO₂ reagent is selected.

9. The method of claim 1, wherein the low-CO₂ reagent has a pH of about 8.3 to about 10.3.

10. The method of claim 1, wherein the low-CO₂ reagent is aged for at least about 1 month before contacting the natural gas.

11. The method of claim 1, wherein the low-CO₂ reagent further comprises an additive selected from the group consisting of CaCl₂, Ca(OH)₂, and any combination thereof.

12. The method of claim 1, wherein the first carbonate precipitate comprises a carbonate selected from the group consisting of FeCO₃, MgCO₃, CaCO₃, ankerites (Ca(Fe,Mg,Mn) (CO₃)₂), nesquehonites (MgCO₃·3H₂O), hydromagnesites (Mg₅(CO₃)₄(OH)₂·4H₂O), and any combination thereof.

13. The method of claim 12, wherein the first carbonate precipitate further comprises at least one mineral selected from the group consisting of amorphous silica, smectites, phyllosilicates, serpentines ((Mg,Fe)₃Si₂O₅(OH)₄), Si₂O₅ minerals, quartz (SiO₂), corundum (Al₂O₃), gibbsites (Al(OH)₃), hematites (Fe₂O₃), and any combination thereof.

14. The method of claim 12, further comprising:
removing the first aqueous slurry from the first reactor;
collecting the first carbonate precipitate; and
optionally, utilizing the first carbonate precipitate in at least one commercial process.

15. The method of claim 1, wherein the pulverized ultramafic rocks and/or the pulverized mafic rocks comprise pyroxenes, forsterites (Mg₂SiO₄), fayalites (Fe₂SiO₄), labradorites, or any combination thereof.

16. The method of claim 1, further comprising:
introducing the sweetened natural gas and a fresh carbonate-forming reagent into a second reactor;
contacting the sweetened natural gas and the fresh carbonate-forming reagent in the second reactor for a sufficient time to form further sweetened natural gas comprising a third amount of carbon dioxide which is lower than the second amount of carbon dioxide and a second aqueous slurry comprising a second carbonate precipitate; and
collecting the further sweetened natural gas from the second reactor.

17. The method of claim 16, wherein the fresh carbonate-forming reagent is different than the carbonate-forming reagent.

18. The method of claim 16, wherein the fresh carbonate-forming reagent comprises the low-CO₂ reagent.

19. A method comprising:
providing natural gas comprising a first amount of carbon dioxide;
providing a high-CO₂ reagent comprising an alkaline aqueous fluid comprising calcium ions and having a pH of about 11.9 to about 13.9;
wherein Ca(OH)₂, CaCl₂, or any combination thereof is dispersed in the alkaline aqueous fluid;
introducing the natural gas and the high-CO₂ reagent into a first reactor;
contacting the natural gas and the high-CO₂ reagent in the first reactor for a sufficient time to form sweetened natural gas comprising a second amount of carbon dioxide which is lower than the first amount of the carbon dioxide and a first aqueous slurry comprising CaCO₃; and
optionally, introducing the sweetened natural gas into a second reactor, and contacting the sweetened natural gas with a fresh carbonate-forming reagent to form further sweetened natural gas comprising a third amount of carbon dioxide which is lower than the second amount of carbon dioxide.

20. A method comprising:
providing natural gas comprising a first amount of carbon dioxide;
providing a low-CO₂ reagent comprising an aged aqueous fluid comprising pulverized ultramafic rocks, pulverized mafic rocks, or any combination thereof and having a pH of about 8.3 to about 10.3;
introducing the natural gas and the low-CO₂ reagent into a first reactor;
contacting the natural gas and the low-CO₂ reagent in the first reactor for a sufficient time to form sweetened natural gas comprising a second amount of carbon dioxide which is lower than the first amount of the carbon dioxide and a first aqueous slurry comprising a first carbonate precipitate;
wherein the first carbonate precipitate comprises a carbonate selected from the group consisting of FeCO₃, MgCO₃, CaCO₃, ankerites (Ca(Fe,Mg,Mn)(CO₃)₂), nesquehonites (MgCO₃·3H₂O), hydromagnesites (Mg₅(CO₃)₄(OH)₂·4H₂O), and any combination thereof; and
optionally, introducing the sweetened natural gas and fresh low-CO₂ reagent into a second reactor, and contacting the sweetened natural gas and the fresh low-CO₂ reagent in the second reactor to form further sweetened natural gas comprising a third amount of carbon dioxide which is lower than the second amount of carbon dioxide and a second aqueous slurry comprising a second carbonate precipitate.
